(19) United States
(12) Patent Application Publication
(10) Pub. No.: US 2016/0080293 A1
(43) Pub. Date: Mar. 17, 2016

(54) Accounts Control

(71) Applicant: Microsoft Corporation, Redmond, WA (US)

(72) Inventors: Karanbir Singh, Seattle, WA (US); Saurav Sinha, Bellevue, WA (US); Sanjay N. Mahida, Seattle, WA (US); Andy Liu, Redmond, WA (US); Gopinathan Kannan, Redmond, WA (US); Nathan Jeffrey Ide, Bothell, WA (US); Tony Ureche, Bellevue, WA (US); Sainath Narendranath Thadkal, Bellevue, WA (US); Alex Radutskiy, Redmond, WA (US); Eric M. Jia, Redmond, WA (US); Kanna Ramasubramanian, Bellevue, WA (US); Yifan Wang, Bellevue, WA (US)

(21) Appl. No.: 14/485,615

(22) Filed: Sep. 12, 2014

(51) Int. Cl. H04L 12/58; H04L 29/08; G06F 21/45; G06F 17/30

(52) U.S. Cl. CPC H04L 51/046; G06F 17/30589; H04L 67/1085; G06F 21/45

(57) ABSTRACT

The techniques discussed herein may facilitate user account management while also protecting a user's personally identifiable information (PII). The user's PII is stored in a protected area, such as a secure operating system area. The techniques may also implement a broker process to access a user's PII. The techniques display a user's accounts that are available for use with an application. The techniques further provide for passing a hint to the application upon receiving selection of an account, wherein the hint indicates which user account is selected, without divulging to the application any of the user's PII.

### BACKGROUND

Many software applications allow a user to use one or more different user accounts with the application. For example, when a user runs an email application on a laptop or mobile device, the user can specify a web-based email provider that the email application can communicate with in order to display emails for the user's email account. For example, the email application can provide a list of different web-based email providers (Microsoft®, Google®, Yahoo®, AOL®, etc.). The user can select a web-based email provider, enter login information for the user's email account, and in response the email application can sync with the user's email account.

After the mail application syncs with the user's email account, the mail application can sync to the same account the next time the user launches the mail application. For example, if the user launches the same mail application the following day, the mail application can sync with the previously-specified account and display all new emails that were received since the previous day. However, if the user decides to launch a new mail application that has not been used before, the new mail application may not know about any of the user's email accounts. Thus, the user's personally identifiable information (PII) stored in one application is typically not available to other applications. Therefore, the user will need to re-select a web-based email provider and re-enter login information for the user's email account so that the new mail application can sync with the user's email account.

### SUMMARY

The techniques discussed herein facilitate user account management while also protecting a user's personally identifiable information (PII). The user's PII is stored in a protected area, such as a secure operating system area. The techniques may also implement a broker process to access a user's PII. The techniques display a user's accounts that are available for use with an application. The techniques further provide for passing a hint to the application upon receiving selection of an account, wherein the hint indicates which user account is selected, without divulging to the application any of the user's PII.

This Summary is provided to introduce a selection of concepts in a simplified form that are further described below in the Detailed Description. This Summary is intended to be used as an aid in determining the scope of the claimed subject matter. The term “techniques,” for instance, may refer to system(s), method(s), computer-readable media/instructions, module(s), algorithms, hardware logic (e.g., Field-programmable Gate Arrays (FPGAs), Application-Specific Integrated Circuits (ASICs), Application-Specific Standard Products (ASSPs), System-on-a-chip systems (SOCs), Complex Programmable Logic Devices (CPLDs)), and/or technique(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates an exemplary operating environment in which various embodiments can operate.

FIG. 2 illustrates an exemplary graphical user interface for allowing a mail application to request access to a user's web accounts.

FIG. 3 illustrates an exemplary graphical user interface that shows web accounts that a mail application has access to.

FIG. 4 is a block diagram illustrating an example process for managing user accounts and protecting user-related data.

FIG. 5 is a block diagram illustrating an example process for protecting user-related data.

FIG. 6 is a flow diagram illustrating an example process for managing user accounts and protecting user-related data.

### DETAILED DESCRIPTION

### Overview

This disclosure is directed to techniques for managing user accounts while protecting user-related data. Examples described herein provide techniques to facilitate user account management while also protecting a user's personally identifiable information (PII) (account information, email, etc.) from applications. In contrast to previous approaches, this technique does not require a user to re-enter user account information for use with multiple software applications. Rather, the user's PII can be stored in a protected area that is inaccessible by applications, such as a secure operating system area, and a broker can be used to access a user's PII. The broker may be a separate software application, operating system process, or other suitable module comprising software and/or hardware. The broker can cause display of a user's web accounts that are available for use with an application. For example, the broker can cause display of a list of web-based email accounts.

In response to receiving a selection of a web account, the broker can pass a hint to the mail application to indicate which user account is selected. In some examples, the hint does not include any of the user's PII. Since the broker does not divulge the user's PII to the calling application, a high level of account security can be maintained. At the same time, user efficiency and reliability may be improved, because a user can select an account from a list of available accounts displayed on a graphical user interface, without the need for a user to re-enter account login information. Furthermore, this technique can eliminate errors associated with data re-entry. Thus, implementing a broker to access protected account data provides an efficient yet secure method for a user to choose an account for use with an application.

The techniques and systems described herein may be implemented in a number of ways. Example implementations are provided below with reference to the following figures. The implementations, examples, and illustrations described herein may be combined.

### Illustrative Environment

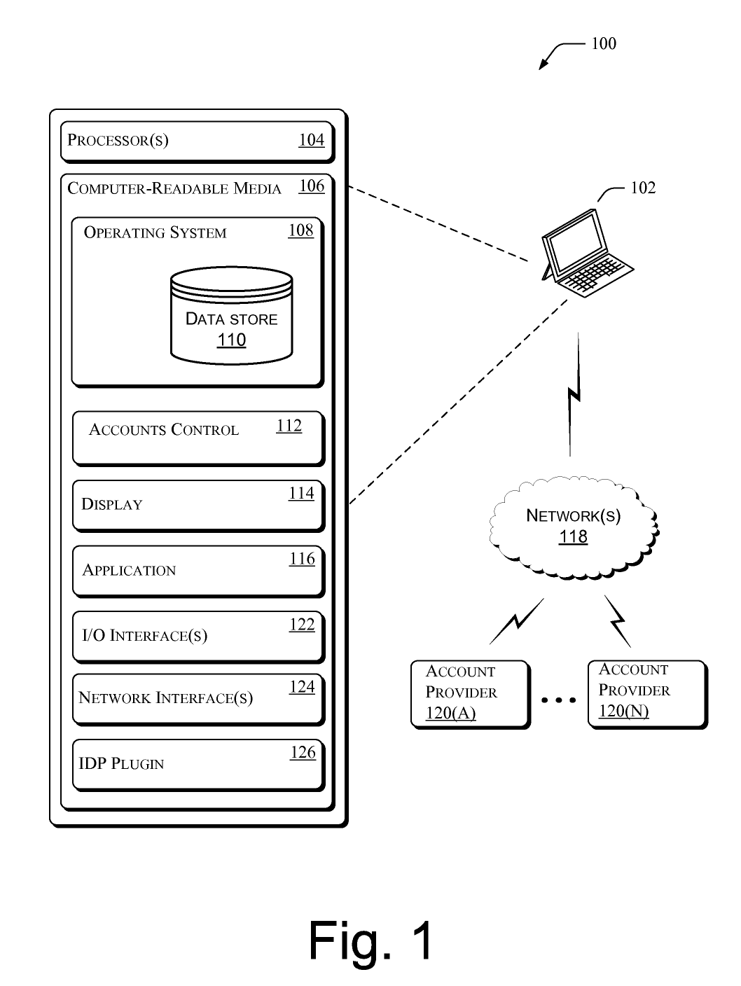

FIG. 1 illustrates an operating environment 100 comprising a computer 102 having one or more processor(s) 104 and a computer-readable media 106. The processor(s) 104 are capable of accessing and/or executing the computer-readable media 106. The processor(s) 104 may access the computer-readable media 106 via a bus, which in some instances may include one or more of a system bus, a data bus, an address bus, a PCI bus, a Mini-PCI bus, and any variety of local, peripheral, and/or independent buses, or via another operable connection.

In various examples, the processor(s) 104 can represent hardware processing units or software processor modules. Software processor modules may comprise software instructions being executed by hardware. The hardware may include circuitry, transistors, memory, buses, and any other physical devices associated with executing and storing instructions. Thus, the processor(s) 104 may comprise a combination of software and hardware, wherein the software is executed and stored on the hardware (e.g., software executing on a desktop, laptop, mobile device, or server). In some examples, the processor(s) 104 may refer to a module or portion of code that executes on hardware to perform a particular function. Thus, the processor(s) 104 may include one or more sub-processors, each sub-processor executing a particular portion of code or providing a particular function.

In some examples of hardware processing units, the processor(s) 104 represent one or more physical hardware devices, such as one or more CPUs, GPUS, microprocessors, chips, dies, programmable arrays, and/or other physical devices. As used herein, while hardware processing units can execute software processor modules, hardware processing units do not include software processing modules.

The computer-readable media 106 comprises an operating system 108 having an associated data store 110. The operating system 108 is capable of managing applications and tasks on the computer 102. The operating system 108 can comprise a data store 110 or be associated with the data store 110, which is capable of storing a user's PII, which includes account information. In some examples, at least a portion of account information is stored and retrieved from a distributed computing environment (e.g., the cloud). For example, an updated version of the data store with updated user account information can be downloaded from the distributed computing environment. The distributed computing environment can comprise servers, storage devices, and various other computing devices capable of communicating with each other through wired and/or wireless networks, described in more detail below.

The computer 102 may also comprise an accounts control 112. The accounts control 112 is an application or brokered process capable of accessing PII from the data store 110 and providing information to a user. In some examples, the accounts control 112 is a process that can run on the operating system 108. In some examples, the accounts control 112 can present a list of user accounts on a display 114 for use with an application 116. For example, the accounts control 112 can display a list of web email accounts (Microsoft®, Google®, Yahoo®, AOL®, etc.) that can be used with a mail application.

Network(s) 118 may include public networks such as the Internet, private networks such as an institutional and/or personal intranet, or some combination of private and public networks. Network(s) 118 may also include any type of wired and/or wireless network, including but not limited to local area networks (LANs), wide area networks (WANs), satellite networks, cable networks, Wi-Fi networks, WiMax networks, mobile communications networks (e.g., 3G, 4G, and so forth) or any combination thereof. Network(s) 118 may utilize communications protocols, including packet-based and/or datagram-based protocols such as internet protocol (IP), transmission control protocol (TCP), user datagram protocol (UDP), or other types of protocols. Moreover, network(s) 118 may also include a number of devices that facilitate network communications and/or form a hardware basis for the networks, such as switches, routers, gateways, access points, firewalls, base stations, repeaters, backbone devices, and the like.

In some examples, network(s) 118 may further include devices that enable connection to a wireless network, such as a wireless access point (WAP). Examples support connectivity through WAPs that send and receive data over various electromagnetic frequencies (e.g., radio frequencies), including WAPs that support Institute of Electrical and Electronics Engineers (IEEE) 1302.11 standards (e.g., 1302.11g, 1302.11n, and so forth), and other standards.

In various examples, one or more account providers 120 can communicate with the computer 102 via the network 118. The account providers 120 can provide services and data for a user. For example, an account provider 120 can provide web email services for a user. Furthermore, each account provider 120 may comprise computers or servers similar to computer 102.

The computer-readable media 106 may include, at least, two types of computer-readable media, namely computer storage media and communication media. Computer storage media may include volatile and non-volatile, non-transitory machine-readable, removable, and non-removable media implemented in any method or technology for storage of information (in compressed or uncompressed form), such as computer (or other electronic device) readable instructions, data structures, program modules, or other data to perform processes or methods described herein. Computer storage media includes, but is not limited to hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions.

In contrast, communication media may embody computer-readable instructions, data structures, program modules, or other data in a modulated data signal, such as a carrier wave, or other transmission mechanism. As defined herein, computer storage media does not include communication media.

The computer 102 may include, but is not limited to, desktop computers, server computers, web-server computers, personal computers, mobile computers, laptop computers, tablet computers, wearable computers, implanted computing devices, telecommunication devices, automotive computers, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device such as one or more separate processor device(s), such as CPU-type processors (e.g., micro-processors), GPUs, or accelerator device(s).

The computer 102 may further include one or more input/output (I/O) interface(s) 122, to allow the computer 102 to communicate with input/output devices such as user input devices including peripheral input devices (e.g., a keyboard, a mouse, a pen, a game controller, a voice input device, a touch input device, a gestural input device, and the like) and/or output devices including peripheral output devices (e.g., a display, a printer, audio speakers, a haptic output, and the like). The computer 102 may also include one or more network interface(s) 124, to enable communications between the computer 102 and other networked devices such as the account provider 120. Such network interface(s) 124 may include one or more network interface controllers (NICs) or other types of transceiver devices to send and receive communications over a network. Furthermore, in some examples, an identify provider (IDP) plugin 126 can retrieve tokens for use with user accounts, as described in more detail below.

### Illustrative User Interfaces

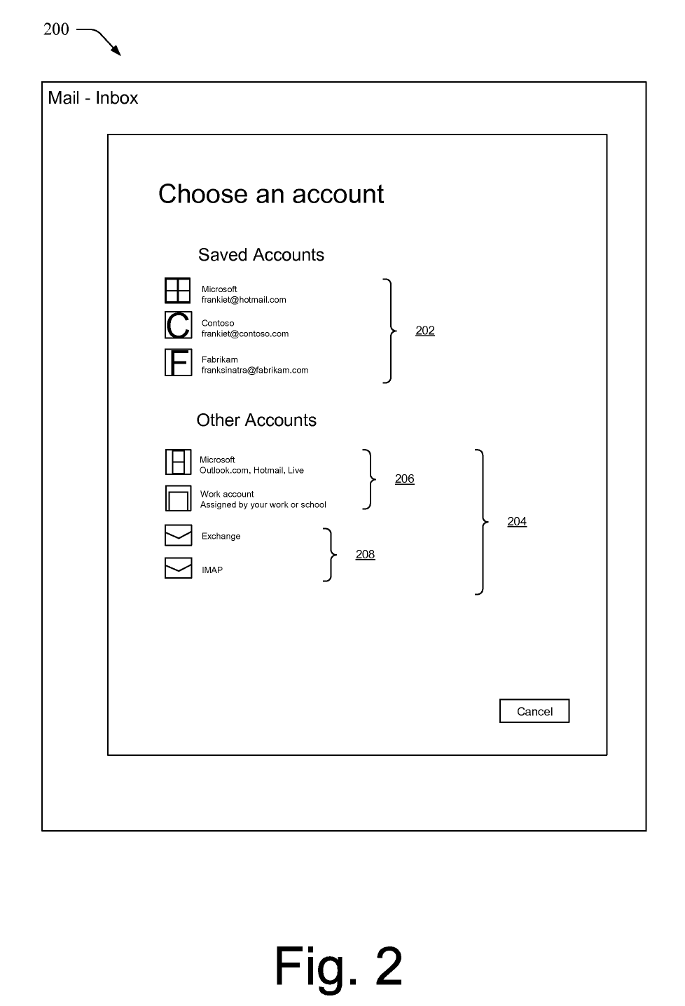

FIG. 2 illustrates an exemplary graphical user interface 200 that can allow a mail application to request access to a user's web accounts. The graphical user interface 200 can include saved accounts 202 and other accounts 204. The saved accounts 202 can include web accounts that are saved in the operating system 108. For example, the saved accounts 202 can be stored in the data store 110. The information saved can include a username, one or more credentials (e.g., password), pictures, photos, and any other suitable information for associating with a user's account. Therefore, in some examples, the graphical user interface 200 can receive a selection of a saved account for use with the application 116 without necessitating entry of sensitive data or credentials such as a username, password, or any other PII.

The other accounts 204 section of the graphical user interface 200 can be used for adding accounts that are not stored in the data store 110. In other words, the other accounts 204 can be used to specify accounts that are stored in another location separate from the data store 110 or operating system 108 and that can be used by the application 116 or configured for the application 116. In the example, the other accounts 204 can include system-specific accounts 206 and application-specific accounts 208. The system-specific accounts 206 can include account providers 120 or account types that are known or recognized by the operating system 108. For example, the operating system 108 may recognize Microsoft® accounts, Google® accounts, Yahoo® accounts, and AOL® accounts. In some examples, in response to receiving a selection of one of the system-specific accounts 206 via an I/O interface corresponding to information represented in the graphical user interface 200, the accounts control 112 launches a software program, such as a software plug-in, to provide for adding a new account to the operating system 108 or data store 110.

On the other hand, the application-specific accounts 208 can include account providers 120 or account types that are known or recognized by the application 116, but not known or recognized by the operating system 108. Therefore, application-specific accounts 208 can be added by using the application 116 itself. In some examples, the application 116 can store the account information for application-specific accounts. In other examples, the operating system 108 or the data store 110 can store some or all of the associated account information after the application 116 adds the new account. Furthermore, in some examples, the operating system 108 can be configured to know or recognize the application-specific accounts 208, which can allow the operating system 108 or the data store 110 to store the accounts for later use.

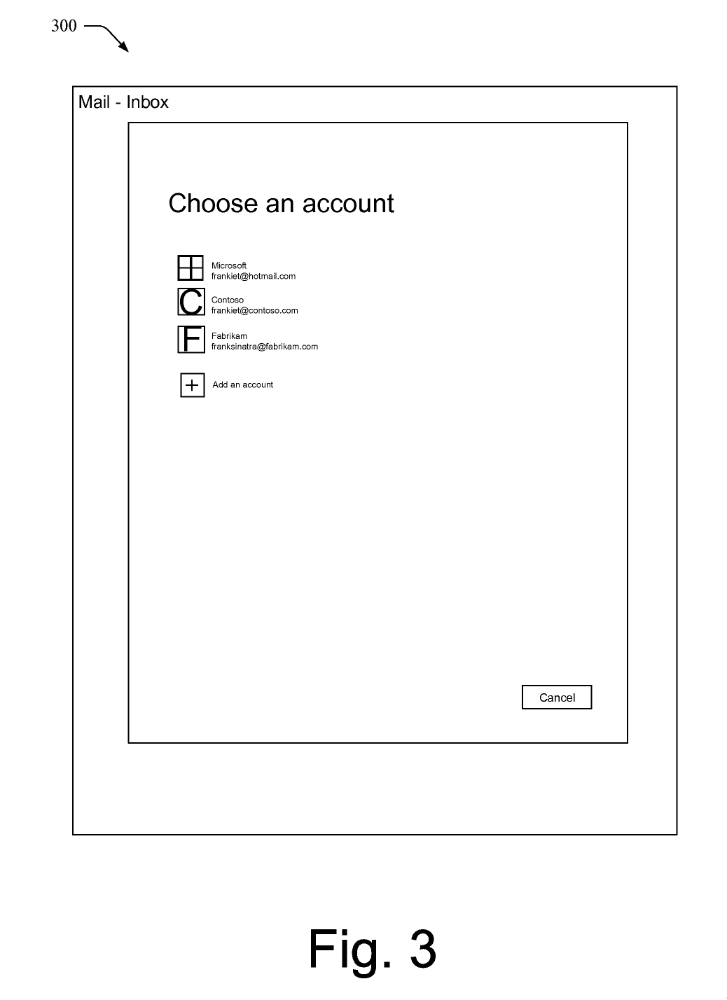

FIG. 3 illustrates an exemplary graphical user interface 300 that shows web accounts that a mail application has access to. The graphical user interface 300 includes accounts that the application 116 has access to. The graphical user interface 300 can allow new accounts to be added to the application 116. In some examples, the accounts can be application-specific accounts 208, as described above. However, the graphical user interface 300 is not needed for applications that are used with the accounts control 112. In other words, applications that can interface with the accounts control 112 can be used with the graphical user interface 200, as described above. Thus, application development time can be reduced, while providing a more consistent user experience across different applications.

### Illustrative Processes

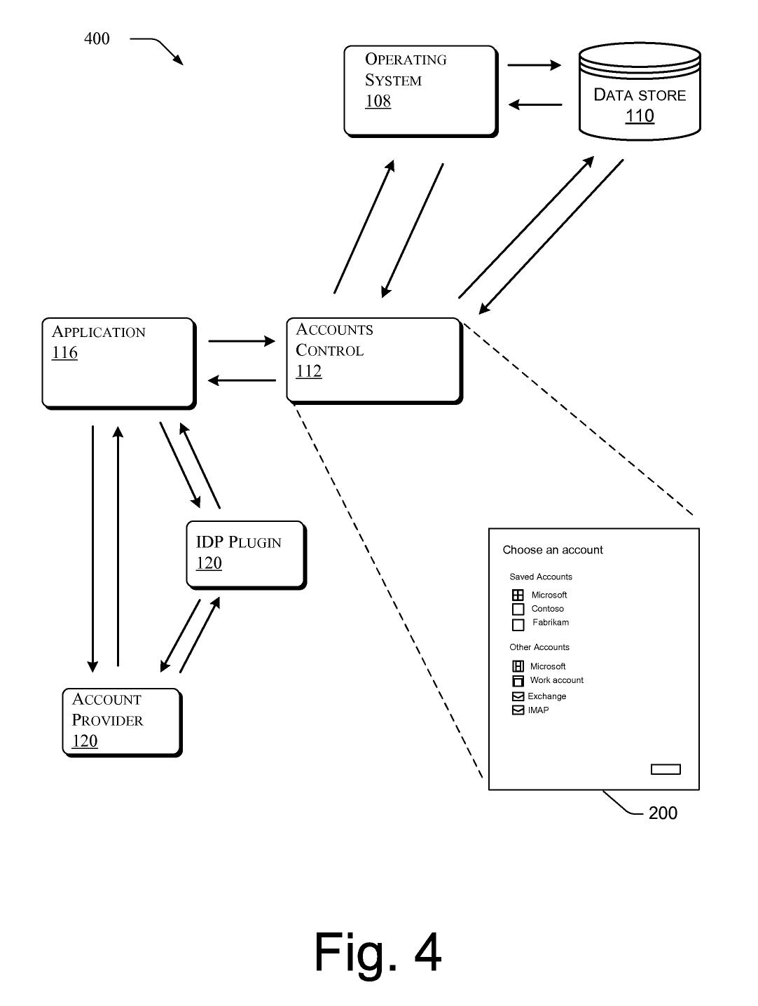

FIG. 4 is a diagram illustrating an example process 400 for managing user accounts and protecting user-related data. After application 116 is launched (e.g., by receiving a selection from a user to launch), the application 116 can communicate with the accounts control 112. For example, the application 116 may query or send a request (e.g., via an API call) to the accounts control 112 or the operating system 108 to provide user account information to the accounts control 112. In some examples, the accounts control 112 can then query or send a request to the operating system 108 for account data for any accounts that the operating system 108 is aware of that can be used with the application 116. The operating system 108 can then obtain data for the accounts from the data store 110 and return the data to the accounts control 112. In some examples, the accounts control 112 can query or send a request directly to the data store 110.

In some examples, at least some of the data store 110 is located in a distributed computing environment (e.g., the cloud). Furthermore, in some examples, account providers, such as Microsoft® and Google®, can communicate directly with the data store 110 or with the accounts control 112.

After receiving the account data from the operating system 108 or the data store 110, the accounts control 112 can display the accounts via the graphical user interface 200. As described above, the graphical user interface 200 can receive a selection from a user of a saved account or to add a new account.

The accounts control 112 can also map a hint to each saved account. The hint can be a number, letter, symbol, character, a combination of one or more of these, or any other suitable identifier that does not divulge any of the user's PII. However, in some examples, the user's email or another portion of the user's PII may be used as a hint. In some examples, a combination of PII and non-PII data can be used a hint. The hint can be a globally unique identifier (GUID) or any other suitable type of identifier that is independent of the PII.

Receiving a selection of a saved account from the graphical user interface 200 can result in a call back to the application 116, along with the hint and an identifier for which IDP plugin 126 or which token broker plugin to call. Receiving selection of a saved account may be accomplished through a mouse click, keyboard, touch (e.g., contact or a predefined user gesture), or any other suitable method of selection for a user interface. In response to receiving the selection of the saved account, the application 116 can request a token and passes in the hint. In response to the request for the token, the operating system 108 can launch the appropriate IDP plugin 126, which can then use the hint to retrieve the appropriate account. Thus, the IDP plugin 126 can map the hint to the appropriate account. In some examples, the IDP plugin 126 can retrieve the token for the user account and return. Thus, the application 116 can retrieve account information from the account provider 120.

In some examples, the application 116 can indicate to the accounts control 112 which account providers 120 that the application supports. For example, the application 116 may indicate that it supports Microsoft® and Google® accounts. In response, the accounts control 112 can query the operating system 108 for Microsoft® and Google® accounts. The operating system 108 can retrieve the Microsoft® and Google® accounts from the data store 110 and can return the relevant account information to the accounts control 112. The accounts control can then display the Microsoft® and Google® accounts in the graphical user interface 200, as described above.

In some examples, the graphical user interface 200 can only display saved accounts for a subset of the account providers 120 indicated by the application 116 because there are not yet any stored accounts for particular account providers. For example, if there are not yet any stored Google® accounts, then graphical user interface 200 may not display any Google® accounts under saved accounts 202. However, the graphical user interface can display Google® under other accounts 204, such as under system-specific accounts 206 or application-specific accounts 208.

In some examples, the data store 110 can exist in a protected area outside of the operating system or in another location or computer separate from the computer 102 (e.g., a server, the cloud, etc.). Furthermore, in some examples, the accounts control 112 can communicate to each account provider 120 directly instead of communicating to the data store 110. For example, the accounts control 112 can communicate directly with Google® to retrieve Google® accounts for display in the graphical user interface 200 and can communicate directly with Microsoft® to retrieve Microsoft® accounts for display in the graphical user interface 200. In some examples, one or more of the account providers 120 can provide display functionality associated with the graphical user interface 200. For example, Google® may provide the graphical user interface 200 with respect to Google® accounts. Similarly, other providers such as Microsoft®, Yahoo®, and AOL® may each provide their own graphical user interface 200. For example, a user may choose to skip the Google® accounts and then select a Microsoft® account for use with the application 116. Thus, the graphical user interface 200 can receive a selection of an application-specific or provider-specific accounts for use with the application 116.

In some examples, the data store 110 can be located in the cloud or another accessible location that is protected. Thus, multiple devices can access the data store for downloading to the device. For example, a user's laptop and mobile phone can both access the data store 110 in the cloud, and thus provide a consistent user experience for both devices. Therefore, after a user saves a new account to the data store 110 using one device, an updated version of the data store 110 can be downloaded to any other devices that the user owns or uses.

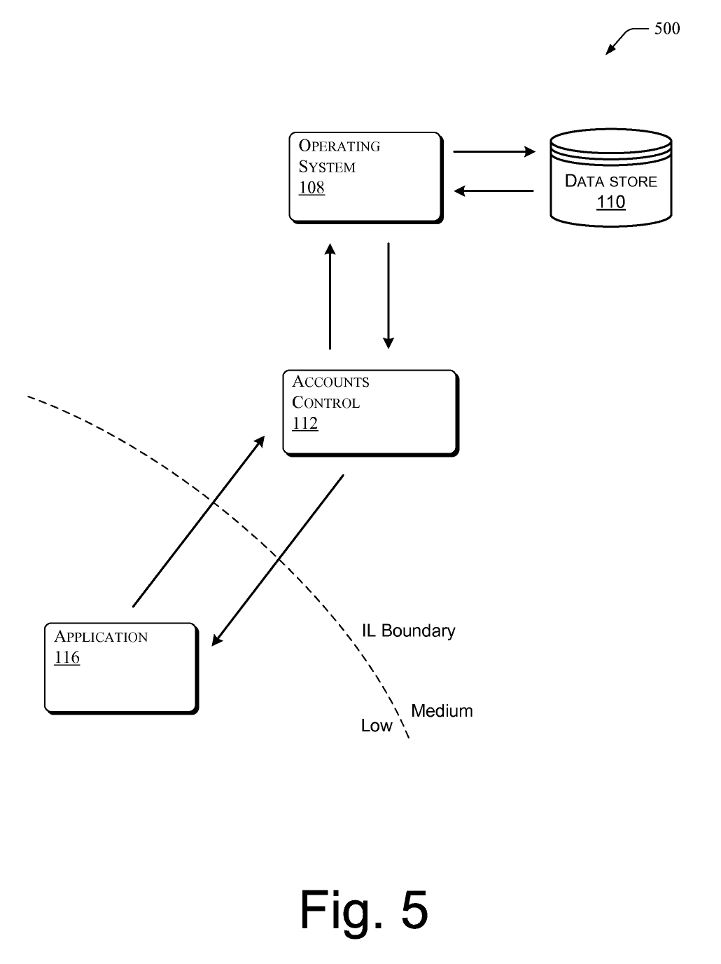

FIG. 5 is a diagram illustrating an example process 500 for protecting user-related data. In the illustrative example, the operating system 108 can assign three levels of security to data: low, medium, and high. However, in other examples, any other number of multiple levels of security can be assigned. The integrity level (IL) boundary 502 represents a boundary between low level security and medium level security. However, in other examples, the IL boundary 502 may represent a boundary between any lower level of security and any other level of security that is higher than the lower level of security. Thus, data stored in the application 116 or associated with the application 116 can be associated with a low level of security, whereas data stored or associated with accounts control 112, operating system 108, and data store can be associated at least with a medium level of security.

Applications that operate in a low security environment (low side of the IL boundary 502) may not have access to data that resides in a medium or high security environment (medium side of the IL boundary 502). However, the accounts control 112 can act as an information broker between the application 116 and the operating system 108. The accounts control 112 can provide data to the application 116 that would otherwise be unavailable to the application 116. Thus, in some examples, the accounts control 112 can be a brokered process, separate from the process of the application 116.

In some examples, the accounts control 112 can pass back metadata to the application 116, such as an id/hint that can map to a user account. Thus, the application 116 can make a call, such as through an API, to acquire a token which can be used for web services, such as obtaining user account information from an account provider 120. Thus, in some examples, the operating system 108 can map a hint to a token, without divulging any PII to the application. Therefore, the accounts control 112 can display the graphical user interface 200, which includes PII that is not accessible to the application 116. In other words, although the graphical user interface 200 can display email addresses and other PII to allow a user to select an account, the application 116 may have no knowledge or access to the PII that is being displayed on the graphical user interface 200.

### Illustrative Operation

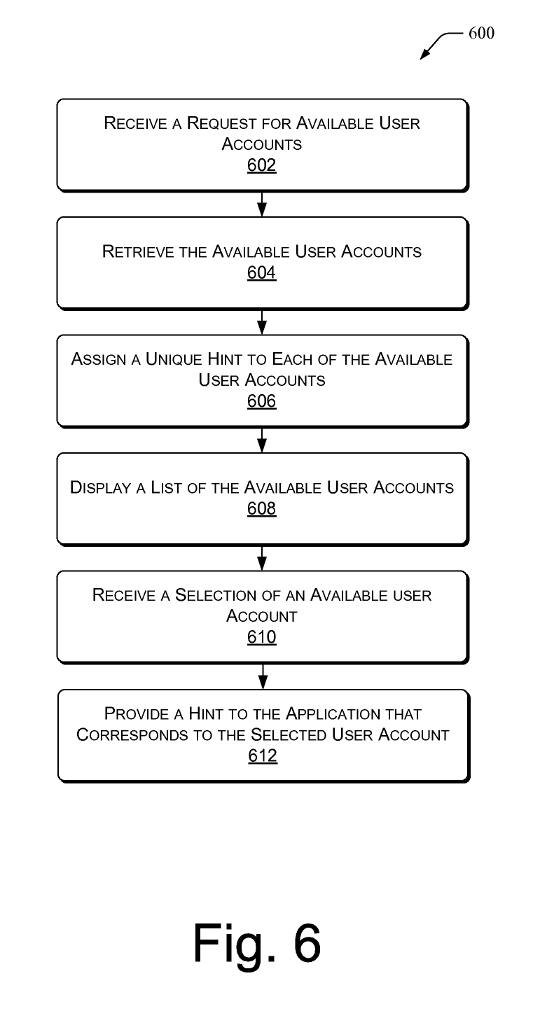

FIG. 6 is a diagram of an illustrative process 600 for managing user accounts and protecting user-related data. The process is illustrated as a collection of blocks in logical flow graphs, which represent a sequence of operations that may be implemented in hardware, software, or a combination thereof. In the context of software, the blocks represent computer-executable instructions stored on one or more computer-readable storage media that, when executed by one or more processors, perform the recited operations. Computer-executable instructions may include routines, programs, objects, components, data structures, and the like that perform particular functions or implement particular abstract data types. The order in which the operations are described is not intended to be construed as a limitation, and any number of the described blocks may be combined in any order and/or in parallel to implement the illustrated process. One or more of the processes described herein may occur independently or in relation in any order, whether in series or parallel. FIG. 6 is an example results from aspects of the processes described herein.

The process 600 is described with reference to the illustrative environment 100, and may be performed by the computer 102 or any other device or combination of devices. Of course, the process 600 (and other processes described herein) may be performed in other environments and/or by other devices. These various environment and device examples are described as “a computing resource,” which may include “a computing device.”

In at least one example, at 602, a computing resource, such the accounts control 112, can receive a request for available user accounts for use with the application 116. For example, a mail application may request available web-based email accounts (Microsoft®, Google®, Yahoo®, AOL®, etc.). At 604, the accounts control 112 can retrieve the available user accounts. For example, the accounts control 112 may retrieve a list of the available user accounts from the operating system 108 or from a data store 110 that is stored within the operating system 108 or that exists external to the operating system 108. At 606, the accounts control 112 can assign a unique hint to each of the available user accounts. For example, the number “1” may be assigned to a first user account, the number “2” may be assigned to a second user account, and so on. At 608, the accounts control 112 can display a list of the available user accounts. At 610, the accounts control 112 can receive a selection of an available user account. For example, a user may select the first user account displayed. At 612, the accounts control 112 can provide a hint to the application that corresponds to the selected user account. Thus, if the user selects the first user account, then the number “1” can be provided to the application.

### Example Clauses

A. A method comprising: receiving, from an application, a request for information for available user accounts for use with the application; retrieving the information for the available user accounts, the information being inaccessible to the application; assigning a unique hint to each of the available user accounts; displaying a list of the available user accounts; receiving a selection of a user account from the list; and providing a hint to the application, the hint corresponding to the selected user account.

B. The method as paragraph A recites, wherein the information for available user accounts includes personally identifiable information (PII).

C. The method as paragraph B recites, wherein the unique hint does not include the PII.

D. The method as either paragraph B or C recites, wherein the unique hint comprises at least a number, character, or symbol.

E. The method as any one of paragraphs A-D recites, wherein the information for the available user accounts is accessible to an operating system.

F. The method as any one of paragraphs A-E recites, wherein the application is associated with a lower security level than the information for available user accounts.

G. The method as any one of paragraphs A-F recites, wherein displaying the list of the available user accounts further comprises displaying a list of account types that are recognized by an operating system.

H. The method as any one of paragraphs A-G recites, wherein the information for the available user accounts is stored in a data store associated with the operating system.

I. The method as any one of paragraphs A-H recites, wherein the information for the available user accounts is stored in a distributed computing environment.

J. A device comprising: one or more processing units; computer-readable media with modules thereon, the modules comprising: an accounts control module configured to: query an operating system for saved user accounts for use with an application; assign a hint to each of the saved user accounts; display a list of the saved user accounts; receive a selection of a user account from the list; and provide a hint to the application, the hint corresponding to the selected user account.

K. The device as paragraph J recites, wherein personally identifiable information (PII) associated with the saved user accounts is inaccessible to the application.

L. The device as paragraph J or K recites, wherein the application is associated with a lower security level than a security level associated with the saved user accounts.

M. The device as any one of paragraphs J-L recites, wherein the accounts control module is associated with a same security level as a security level associated with the saved user accounts.

N. The device as any one of paragraphs J-M recites, wherein the saved accounts are stored in a data store, wherein the data store is at least in part separate from the operating system.

O. The device as any one of paragraphs J-N recites, wherein the accounts control module receives an indication of types of accounts that can be used with the application.

P. One or more computer-readable media storing computer-executable instructions that, when executed on one or more processors, configure a computer to perform acts comprising: receiving a request for saved user accounts for use with an application, the saved user accounts inaccessible to the application; retrieving the saved user accounts from a data store; displaying a list of the saved user accounts; receiving a selection of a user account from the list; providing, to the application, an indication of the selected user account.

Q. The computer-readable media as paragraph P recites, wherein the acts further comprise assigning a unique hint to each of the available user accounts, and wherein providing, to the application, the indication of the selected user account comprises providing, to the application, a hint corresponding to the selected user account.

R. The computer-readable media as either paragraph P or Q recites, wherein the data store is associated with a higher level of security than the application.

S. The computer-readable media as any one of paragraphs P-R recites, wherein the data store is associated with a same security level as the operating system.

T. The computer-readable media as any one of paragraphs P-S recites, wherein retrieving the saved user accounts from the data store comprises downloading an updated version of the data store from a distributed computing environment.

### CONCLUSION

Although the subject matter has been described in language specific to structural features and/or methodological acts, it is to be understood that the subject matter defined in the appended claims is not necessarily limited to the specific features or acts described. Rather, the specific features and steps are disclosed as example forms of implementing the claims.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “may” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A method comprising:
receiving, from an application, a request for information for available user accounts for use with the application;
retrieving the information for the available user accounts, the information being inaccessible to the application;
assigning a unique hint to each of the available user accounts;
displaying a list of the available user accounts;
receiving a selection of a user account from the list; and
providing a hint to the application, the hint corresponding to the selected user account.

2. The method of claim 1, wherein the information for available user accounts includes personally identifiable information (PII).

3. The method of claim 2, wherein the unique hint does not include the PII.

4. The method of claim 3, wherein the hint comprises at least a number, character, or symbol.

5. The method of claim 1, wherein the information for the available user accounts is accessible to an operating system.

6. The method of claim 1, wherein the application is associated with a lower security level than the information for available user accounts.

7. The method of claim 1, wherein displaying the list of the available user accounts further comprises displaying a list of account types that are recognized by an operating system.

8. The method of claim 1, wherein the information for the available user accounts is stored in a data store associated with the operating system.

9. The method of claim 1, wherein the information for the available user accounts is stored in a distributed computing environment.

10. A device comprising:
one or more processing units;
computer-readable media with modules thereon, the modules comprising:
an accounts control module configured to:
query an operating system for saved user accounts for use with an application;
assign a hint to each of the saved user accounts;
display a list of the saved user accounts;
receive a selection of a user account from the list; and
provide a hint to the application, the hint corresponding to the selected user account.

11. The device of claim 10, wherein personally identifiable information (PII) associated with the saved user accounts is inaccessible to the application.

12. The device of claim 10, wherein the application is associated with a lower security level than a security level associated with the saved user accounts.

13. The device of claim 10, wherein the accounts control module is associated with a same security level as a security level associated with the saved user accounts.

14. The device of claim 10, wherein the saved accounts are stored in a data store, wherein the data store is at least in part separate from the operating system.

15. The device of claim 10, wherein the accounts control module receives an indication of types of accounts that can be used with the application.

16. One or more computer-readable media storing computer-executable instructions that, when executed on one or more processors, configure a computer to perform acts comprising:
receiving a request for saved user accounts for use with an application, the saved user accounts inaccessible to the application;
retrieving the saved user accounts from a data store;
displaying a list of the saved user accounts;
receiving a selection of a user account from the list; and
providing, to the application, an indication of the selected user account.

17. The computer-readable media of claim 16, wherein the acts further comprise assigning a unique hint to each of the available user accounts, and wherein providing, to the application, the indication of the selected user account comprises providing, to the application, a hint corresponding to the selected user account.

18. The computer-readable media of claim 16, wherein the data store is associated with a higher level of security than the application.

19. The computer-readable media of claim 16, wherein the data store is associated with a same security level as the operating system.

20. The computer-readable media of claim 16, wherein retrieving the saved user accounts from the data store comprises downloading an updated version of the data store from a distributed computing environment.
